(19) United States
(12) Patent Application Publication
(10) Pub. No.: US 2026/0176786 A1
(43) Pub. Date: Jun. 25, 2026

(54) METHOD FOR PRODUCING A FUNCTIONAL STRUCTURE, AND FUNCTIONAL STRUCTURE

(71) Applicant: FRIEDRICH-ALEXANDER-UNIVERSITÄT ERLANGEN-NÜRNBERG (FAU) PERSONALKÖRPERSCHAFT DES ÖFFENTLICHEN RECHTS, Erlangen (DE)

(72) Inventors: Gerald GOLD, Erlangen (DE); Andreas HOFMANN, Erlangen (DE); Konstantin LOMAKIN, Nürnberg (DE); Mark SIPPEL, Fürth (DE)

(21) Appl. No.: 19/124,530

(22) PCT Filed: Oct. 24, 2023
(86) PCT No.: PCT/EP2023/079642

§ 371 Date: Aug. 27, 2025

(30) Foreign Application Priority Data
Oct. 26, 2022 (DE) 10 2022 128 354.2

(51) Int. Cl. C25D 5/56; B33Y 80/00; H01P 3/12; H01Q 1/36

(52) U.S. Cl. CPC C25D 5/56; H01P 3/12; H01Q 1/36; B33Y 80/00

(57) ABSTRACT

The present invention relates to a method for manufacturing a functional structure having the steps of: providing a base body of the functional structure; applying at least one metallic layer to a surface of the base body, wherein the surface of the base body has one or more anchoring elements at least in certain areas, which are designed and arranged to improve the adhesion of the metallic layer to the surface compared to an adhesion of the metallic layer to a surface without anchoring elements.

### CROSS REFERENCE TO RELATED APPLICATIONS

The present application is a U.S. National Phase of International Application No. PCT/EP2023/079642 entitled “METHOD FOR PRODUCING A FUNCTIONAL STRUCTURE, AND FUNCTIONAL STRUCTURE,” and filed on Oct. 24, 2023. International Application No. PCT/EP2023/079642 claims priority to German Patent Application No. 10 2022 128 354.2 filed on Oct. 26, 2022. The entire contents of each of the above-listed applications are hereby incorporated by reference for all purposes.

### TECHNICAL FIELD

The present invention relates to a method for manufacturing a functional structure having the steps of: providing a base body of the functional structure; applying at least one metallic layer to a surface of the base body.

### BACKGROUND AND SUMMARY

Such a functional structure is, for example, a waveguide for guiding electromagnetic waves. Electromagnetic waves, in particular high-frequency signals, can propagate either in a space or in waveguide devices. Such waveguide devices provide conductive structures that encompass a spatial area and thus form a spatial path or channel to guide the electromagnetic waves or high-frequency signals therein or to manipulate them in space or frequency range.

In the manufacture of high-frequency components, the component is assembled from two halves, in particular to create cavities. The cavities created in this way, e.g. milled into a metallic base body, provide the actual functionality of the high-frequency module. These can be, for example, waveguides, so-called hollow waveguides, but also filters, resonators, couplers or antennas.

Such high-frequency components can be produced from plastic base bodies. They must be provided with a conductive coating to ensure that they function properly later on. The state of the art is galvanic or electroless coating with metals. This is also done, for example, in decorative coating (plating on plastics (PoP)), wherein various coating systems, for example with Cu, Ni, Cr, Au, Ag, etc. and combinations and/or sequences of these elements are used.

The electrical conductivity and nature of the component surface that interacts with the electromagnetic wave is essential; in particular, an inner wall forming the cavity must be electrically conductive. Manufacturing the components from metal or electrically conductive base material is not only cost-intensive, but also time-consuming, in particular making cost-intensive CNC milling processes necessary. Against this background, the prior art has already pursued the approach of manufacturing such components from plastic instead and only making them conductive in one or more downstream steps. Known suggested processes include chemical methods such as galvanic or electroless coating of the base body surface with metals.

The metallisation of plastics, in particular photopolymers, presents technical challenges, in particular with regard to the adhesion of the metal layer to the surface of the plastic. In principle, metallic coatings have poor adhesion to photopolymers. The adhesion of the deposited metal layer may also be insufficient on other plastics, in particular 3D-printable or 3D-printed plastics, which have a low surface roughness, for example with R_{q}<20 μm.

In the prior art, bodies made of photopolymers are therefore subjected to a complex process of sulphonation of the surface to be metallised in order to achieve better adhesion of the metallic layer to the surface.

Coating processes using hexavalent chromium are also known. However, these coating processes are subject to severe legal restrictions or bans due to the harmfulness of hexavalent chromium.

In addition, pickling with hexavalent chromium, for example using chromium-sulphuric acid, achieves a significant increase in surface roughness, which is ultimately at least one of the mechanisms promoting adhesive strength.

With regard to the previously known methods, there is a desire to further simplify the coating process in order to improve the adhesive strength in particular.

Against this background, the object of the present invention is to provide such an improved method.

This object is achieved by the method with the features as described herein.

Accordingly, according to the invention, it is provided that the surface of the base body has one or more anchoring elements at least in certain areas, which are designed and arranged to improve the adhesion of the metallic layer to the surface compared to an adhesion of the metallic layer to a surface without anchoring elements.

The metallic layer can also be electrically conductive.

A particularly preferred embodiment of the method is one in which the base body is monolithic, i.e. is manufactured in one piece and consists of only one material, preferably manufactured using an additive method, the metallic layer is applied wet-chemically and a further metallic layer is applied by an electroplating process, wherein the functional structure is preferably an, in particular slotted, hollow waveguide or waveguide. The galvanic process preferably smooths the surface of the layer, in particular the functional surface.

However, the functional structure may also be a component composed of several parts, in which one or more parts have been produced by a method according to the invention.

For example, the adhesion, in particular the adhesive strength of the coating on the base body, can be tested or estimated by a scratch test in accordance with DIN EN ISO 20502:2016-11, by a Rockwell indentation test in accordance with DIN EN ISO 26443:2016-09 or in accordance with VDI 3824-4, by a cross-cut test in accordance with DIN EN ISO 2409:2020-12, by a cross-cut test and/or cross-cut test in accordance with DIN EN ISO 16276-2:2007-08, by a pull-off test in accordance with DIN EN ISO 4624 or by a similar test method. Testing can also be carried out by applying a fabric adhesive tape and pulling it off, wherein the pull-off force is felt or measured.

Preferably, improved adhesion is understood to mean that at least one of the test methods mentioned above gives a better result or a better test value when testing the adhesion of a layer applied to a surface of a base body with anchoring elements compared to a test of the adhesion of a layer applied to a surface of a base body without anchoring elements.

The anchoring elements preferably increase the surface to which the layer is applied and/or the anchoring elements preferably form form-fitting connections between the base body and the layer. This improves the physical or chemical adhesion and/or the mechanical adhesion of the coating to the base body.

Preferably, it is provided that the anchoring element(s) comprise or are recesses penetrating into the surface and/or projections protruding from the surface and/or have undercuts and/or are produced by the roughness of the surface.

The surface preferably has flat regions and regions that are provided with anchoring elements. An undercut of an anchoring element, which in particular is designed as a recess, is preferably understood to mean that a line extending from the undercut and perpendicular to the flat region penetrates the base body. The undercut thus forms a kind of barb, through which the layer is positively connected to the base body.

The anchoring elements can have any shape. For example, the anchoring elements can be arranged in a type of marbling.

The recesses and/or elevations can take the form of bumps, peaks or the like.

One conceivable geometry for an anchoring element with an undercut is, for example, a recess having a conical cross-section, wherein the recess is widened in the depth direction.

Other conceivable geometries for an anchoring element are cylinders, triangles, tetrahedrons, blocks, trapezoidal blocks, spheres or spherical shapes as well as any free-form shapes.

It is also conceivable that the geometry of the anchoring elements may change during manufacture compared to the target geometry. This can result in distortions or growth. Nevertheless, the anchoring elements preferably fulfil the purpose of increasing the adhesive strength. Adhesion and adhesive strength are preferably to be understood synonymously.

The spatial extension of the anchoring elements, preferably in the direction of the surface, on surfaces interacting with an electromagnetic wave is preferably based on the wavelength Lambda_0=c_0/f, of the electromagnetic wave and/or on the wavelength Lambda_g=2*pi/Beta guided in the hollow waveguide, where Beta is the phase coating of the hollow waveguide. Beta=2*pi*f/(c0*sqrt(epsr))sqrt(1−(f_c/f)²) where f_c=c0/(2*w) where w=the width of the hollow waveguide.

The anchoring elements each have an extension, preferably in the direction of propagation of the electromagnetic wave, which is less than the whole, preferably less than half, in particular less than a quarter, of the wavelength of the electromagnetic wave.

On non-HF-relevant surfaces, it is also conceivable to significantly increase the spatial dimensions of the anchoring elements.

It is conceivable that a plurality of anchoring elements are evenly or unevenly distributed on the surface, wherein the anchoring elements have the same shape or at least one anchoring element has a different shape.

It is conceivable that the anchoring elements are produced by a 3D printer.

In other words, the anchoring elements on the surface can have a different surface density, i.e. the number of anchoring elements per unit of surface area.

The surface density can be changed depending on the desired frequency range of an electromagnetic wave transmitted via the functional structure. The higher the application frequency, the higher the surface density and the smaller the expansion of these anchoring elements in the direction of the surface can be.

A surface density of more than one anchoring element per square centimetre is advantageous, in particular more than one anchoring element per square millimetre, and/or wherein the surface density is preferably a maximum of 100,000, preferably 40,000, in particular 10,000 anchoring elements per square millimetre.

The surface density can also be less than 100 or less than 10 anchoring elements per square millimetre.

It is conceivable that the anchoring elements are produced during the manufacture of the base body or are attached to or inserted into the base body after manufacture.

In a particularly preferred variant of the method, the surface provided with anchoring elements remains a continuous surface. The anchoring elements are therefore preferably surrounded by a surface that defines the function of the component.

This preferably enables basic manufacturability that is largely independent of the orientation in the 3D printed build space, wherein the quality of the surface can continue to vary without supporting the individual anchoring elements.

Furthermore, the outermost regions of the surface determining the function of the HF component preferably remain of high quality, as the roughness is not unnecessarily increased there, for example by aggressive chemical pickling.

It is conceivable that the metallic layer is applied to the surface having at least one anchoring element using a wide variety of methods, such as PVD, CVD, sputtering, inkjet, aerosol jet, nanojet, roll-to-roll printing, screen printing, physical application using inks or pastes or lacquers, chemical methods using wet-chemical deposition or galvanic deposition.

In particular, electroless and galvanic deposition of metal layers are advantageous.

It is conceivable to arrange the anchoring elements on any 3D-printed surface in order to increase the adhesive strength of a metal layer deposited thereon.

Preferably, however, the base bodies are HF components, in particular HF components designed on the basis of slotted hollow waveguide technology. A slotted hollow waveguide is preferably a hollow waveguide with openings in the outer wall that do not lead to radiation. This is the case if the openings are small compared to the guided wavelength and/or do not intersect the current density associated with the wave in the hollow waveguide on the conductive wall at right angles to its direction of flow.

In an advantageous embodiment, it is provided that the metallic layer is applied by means of a, preferably electroless, wet-chemical process, preferably by wetting a part of or the entire surface of the base body with a dispersion containing microparticles and/or nanoparticles, wherein the microparticles and/or nanoparticles preferably have nickel, copper, silver, gold, zinc, tin, chromium, palladium and/or platinum.

Preferably, it is provided that the metallic layer is deposited by means of one of the following methods: PVD, CVD, sputtering, inkjet, aerosol jet, nanojet, roll-to-roll printing, screen printing, physical application using inks or pastes or lacquers, chemical methods using wet-chemical deposition or galvanic deposition.

Particles with an average particle size D50 smaller than 1 μm can be called nanoparticles and particles with an average particle size D50 greater than or equal to 1 μm can be called microparticles. Nanoparticles can have an average particle size D50 of 10 nm to 300 nm, preferably from 10 nm to 100 nm. Microparticles can have an average particle size D50 of 1 μm to 100 μm, preferably from 1 μm to 5 or 10 μm. The particle size preferably refers to the equivalent diameter of the respective particles.

The electrically conductive layer is preferably a layer having metal. The electrically conductive layer can also be electrically non-conductive after application and/or become electrically conductive after application.

The base body can determine the shape of the functional structure.

The particles preferably consist of one or more metals or have one or more metals.

The particles can be coated with plastic.

For the purposes of this invention, electrical is the generic term for electrical and/or electronic.

When manufacturing a functional structure for electrical components, it is preferable to first create a base body that determines the shape of the functional structure. The material used to manufacture the base body is preferably electrically non-conductive, but an electrically conductive or semi-conductive material could just as easily be used to manufacture the base body.

The metallic coating of the base body is preferably achieved by wetting at least a part, preferably the entire surface of the base body with an electrically conductive dispersion containing microparticles and/or nanoparticles. The dispersion can be an ink with microparticles or nanoparticles. The (ink) materials used are preferably those that achieve high conductivities. The dispersion or ink is preferably water-based, and an organic release agent may also be provided. Alternatively or additionally, a solvent may be added. Conceivable particles are aluminium, silver, gold, tin, zinc or copper particles or a mixture thereof. The dispersion or ink is matched to the surface energy of the base body material used, e.g. plastic, so that sufficient wetting of the surface is favoured. Furthermore, the viscosity of the dispersion or the ink material can be matched to the smallest openings in the base body structure so that wetting by the dispersion is ensured.

After evaporation/vaporisation of the solvent/water, the surface of the base body is wetted with the ink material and a conductive coating is formed by optional post-treatment, preferably sintering. The novel method thus represents an alternative to chemical, electroless coating. The base material body is preferably functionalised, i.e. turned into an electrical component, by coating it completely or partially with conductive ink material.

In contrast to chemical coating methods, in which a body is placed in a reagent liquid and a chemical reaction occurs between the reagent liquid and the surface of the body, the present method instead relies on a dispersion for coating, which physically wets the base body and forms a conductive coating by post-treatment.

Compared to the chemical coating method, a smoother surface structure of the coated base body can be achieved using the method according to the invention, which has decisive advantages, in particular for components used in high-frequency technology. The smoother the surface of the component, the better the subsequent electrical performance of the component. The chemical process of existing methods often leads to an unfavourable roughening of the body surface due to the pre-treatment required.

The method according to the invention can be advantageously used, for example, for the manufacture of electrical components, wherein the functional structure of these components is formed by the coated base body. Some of these functional structures require a spatial area enclosed by conductive structures to guide the electromagnetic waves. In this case, the base body is designed with corresponding structures at the points required for the electrical function, where it is needed for the mechanical or electrical function or only slightly restricts the electrical function.

Application and wetting is preferably carried out by completely immersing the base body in an immersion bath containing the corresponding dispersion. In principle, a single immersion of the base body is sufficient. A better distribution of the dispersion around or through the base body, in particular in an optionally provided cavity, is ensured by repeated immersion. Preferably, an ultrasonic bath containing the dispersion is used. After immersion in the immersion bath, the base body can be shaken briefly to remove excess dispersion.

As an alternative to the immersion bath, the dispersion can also be applied using an aerosol chamber, in which the dispersion atomised into droplets wets the base body. It is also possible to coat or wet the base body by spraying or pouring the dispersion over it.

It is conceivable that the metallic layer could be applied using an aerosol or nanojet.

It is also conceivable that the dispersion is applied by flushing.

After application of the dispersion, the quality of the coating and its conductivity can be produced or improved by thermal post-treatment of the base body surface or the adhering microparticles or nanoparticles. Drying, preferably in a circulating air system, sintering in a furnace, UV treatment, hot air or infrared radiation are suitable for this purpose. Thermal post-treatment can have a positive effect on the electrical conductivity of the applied coating. Subsequent sintering of the microparticles or nanoparticles, e.g. in a thermal furnace, achieves a high conductivity of the resulting surface coating. The sintering temperature of the ink material is matched to the glass transition temperature of the plastic used so that it is not damaged.

It can be provided that no thermal post-treatment, in particular no drying, of the base body takes place.

It can also be advantageous if the surface of the base body is pretreated before the dispersion is applied, in particular to achieve surface cleaning or activation for optimised adhesion of the coating.

During the coating process, in particular when introducing the product into an appropriate immersion bath, it is essential that the appropriate dispersion can reach all the inner wall surfaces to be coated. To promote fluid circulation, it can therefore also be advantageous to design the base body in such a way that base body material is only present where it is required for the mechanical or electrical function or only slightly restricts it, i.e. certain walls of the base body are only constructed there from the outset or are subsequently provided with recesses. This makes it easier for the dispersion to penetrate into a cavity. Furthermore, the viscosity of the dispersion or ink material used should be matched to the smallest openings in the base body structure so that circulation is guaranteed.

In the case of rectangular hollow bodies or cavities, walls corresponding to the side walls of a substrate integrated waveguide (SIW) known in the prior art can be interrupted, as these openings do not impair the high-frequency or electrical function, which is also known in the prior art. For example, the narrow-sided walls of the cavity are slotted, while the wide-sided walls of the rectangular hollow body can be designed without corresponding openings.

In a further advantageous embodiment, it is provided that the metallic layer is applied to the surface having at least one anchoring element by means of a wet-chemical process, preferably by electroless deposition of nickel, copper, silver, gold, tin, zinc, etc.

Furthermore, in an advantageous embodiment, it is provided that the electrolessly applied metallic layer on a surface having at least one anchoring element is subsequently extended with at least one further metallic layer by an electrochemical and/or galvanic method. The galvanically deposited metallic layer imitates the surface and the anchoring elements, and the latter remain recognisable after the galvanic coating.

In a further advantageous embodiment of the method, it is provided that the electrolessly applied metallic layer on a surface having at least one anchoring element is subsequently extended with at least one further metallic layer by an electrochemical and/or galvanic process. The galvanic layer is deposited in such a way that the anchoring elements are sealed or completely covered by this layer.

Another advantageous embodiment of the method provides that the galvanic deposition of one or more metallic layers is carried out in such a way that effective smoothing of the outermost surfaces is achieved, as is carried out in DE 10 2021 128 881 A1. This reduces losses for electromagnetic waves.

As mentioned above, the base body can be made of an electrically non-conductive material. Ceramic or plastic are particularly suitable for this purpose. The plastic can be polyamide, preferably PA6, PA11 or PA12. In particular, the plastic can be a photopolymer. The plastic material may contain polyurethanes or acrylates. It can also be provided that the base body is a hollow body and its inside is coated with the metallic layer.

Preferably, it is provided that the method comprises the further step of:

applying at least one further metallic layer to the base body by means of a galvanic or wet-chemical process.

Applying a further metallic layer once or several times preferably leads to a functional smoothing of the surface of the layer.

A functionally smooth surface is preferably understood to mean that the layer is designed in such a way that the function of the layer is not impaired. If the function of the layer is the conduction of electromagnetic waves, a functionally smooth surface of a layer for the waveguiding function is designed in such a way that the waveguiding is not influenced by the anchoring elements.

The anchoring elements or the microstructure can therefore also be optically visible on a surface that is functionally smooth for the waveguiding function. The surface provided with anchoring elements can be described as a microstructure.

The smoothing of the surface or microstructure is preferably carried out to reduce electromagnetic losses or to reduce the attenuation of an electromagnetic wave that is conducted through the functional structure.

In an advantageous embodiment, it is provided that the layer(s) cover the anchoring elements after application of the layer(s) in such a way that the layer has a, preferably functional, smooth, flat and/or continuous surface, wherein the anchoring elements are preferably visible, partially visible or invisible.

The anchoring elements can also be partially recognisable in shape.

A recess as an anchoring element can, for example, be filled with the layer in such a way that a recess is still visible. However, the recess can also be filled with the layer in such a way that the layer completely fills the recess, making it invisible.

A recess as an anchoring element can, for example, also be covered by a layer deposited thereon, wherein the recess is filled, for example in the manner of a seal. However, a covered layer can also be deposited so that a cavity remains.

Another advantageous embodiment of the method provides for anchoring elements protruding above the surface, for example small towers, which are covered by the metallic layer in such a way that they disappear under the layer.

Thanks to a continuous surface, the manufacturability is maintained even on overhanging regions and the surface preferably has the same shape as before the layer was deposited. In particular, the intended high-frequency functionality of the surface is still maintained because the anchoring elements do not interact with electromagnetic waves or do not interact significantly with them.

It is conceivable that the anchoring elements are only arranged on surfaces of the base body that have a function.

It is also conceivable that the anchoring elements are arranged only on surfaces of the base body that have no function or only or also on surfaces of the base body that have a function, in particular on the inner sides of a, preferably slotted, hollow waveguide or on the radiating surfaces of an antenna.

In another advantageous embodiment of the method, the distribution and formation of the anchoring elements is adapted to the functions of the surface. This means that surfaces that do not have high-frequency (HF) functionality can have anchoring elements in a much more pronounced form, for example in the form of large and/or deep caverns. Anchoring elements adapted to the frequency and application, for example with a smaller spatial extent, can be installed on the surfaces having HF functionality. However, it is also conceivable that the surfaces with HF functionality could be designed entirely without anchoring elements.

In an advantageous embodiment, it is provided that the functional structure is designed to conduct an electromagnetic wave, wherein the anchoring elements each have an extension, preferably in the direction of propagation of the electromagnetic wave, which is less than the whole, preferably less than half, preferably less than a quarter, of the wavelength of the electromagnetic wave.

The size of the anchoring elements, preferably in the direction of expansion of the surface, can be orientated not only to the wavelength but also to the surface density. It is conceivable that at least one anchoring element is placed per square centimetre. In particular, surface densities of at least one anchoring element per square millimetre are advantageous.

It is conceivable that regions of the outermost layer are smoothed, in particular by means of galvanic smoothing or smoothing of the base body before the layer is applied.

It is conceivable that the base body is manufactured by an additive method, wherein the additive method comprises SLS, SLA, DLP, multijet, 2-photon printing, aerosol jet, inkjet, nanojet, FDM, SLM and/or EBM.

Preferably, it is provided that the base body consists at least partially or completely of ceramic, plastic, in particular a photopolymer, or metal and/or in that the base body is a hollow body, wherein the inside of the hollow body is coated with the metallic layer and/or in that the base body is formed or produced in one piece or in several parts. The base body can also consist partially or completely of a material for selective laser sintering.

In an advantageous embodiment, it is provided that the base body is produced by an additive method, in particular by 3D printing, selective laser sintering or stereolithography, multijet or by a casting method, in particular by injection moulding.

The anchoring elements are preferably produced during the manufacture of the base body and are not attached to or inserted into the base body separately. This is conceivable in particular if the base body is manufactured using an additive method. In principle, however, it is also conceivable to attach or insert the anchoring elements separately to produce the base body. It is also conceivable that the anchoring elements are prepared by 3D printing and then formed in a downstream process step.

Preferably, it is provided that the functional structure is or comprises an electrical or high-frequency functional structure, a high-frequency line, in particular a, preferably slotted, hollow waveguide, or an antenna, in particular a horn or helix antenna, or a filter or a resonator or a coupler or another passive HF part or component of a solar system, a solar cell, a touch screen, a smart glass, a wearable or an LED or a moulded interconnect device (MID) or mechatronic integrated device (MID) or a decorative structure.

The invention also relates to a high-frequency functional structure that has been partially or completed manufactured by means of a method according to the invention, the functional structure having at least one metallic layer on a surface of a base body provided with anchoring elements.

It is conceivable that the anchoring element(s) comprise or are recesses penetrating into the surface and/or projections protruding from the surface and/or have undercuts and/or are produced by the roughness of the surface.

It is conceivable that the layer(s) cover the anchoring elements in such a way that the layer has a, preferably functional, smooth, flat and/or continuous surface, wherein the anchoring elements are preferably visible, partially visible or invisible.

It is conceivable that the anchoring elements are arranged only on surfaces of the base body that have no function or only or also on surfaces of the base body that have a function, in particular on the inner sides of a, preferably slotted, hollow waveguide or on the radiating surfaces of an antenna.

The features described herein are mutatis mutandis preferably features of the product as well as of the method. In other words, the features described herein with respect to the method may also be embodied in a corresponding structure, and the features described herein with respect to a structure may be embodied in a corresponding method utilizing such a structure. Descriptions of method features are intended to encompass the corresponding structural features, and descriptions of structural features are intended to encompass the corresponding method steps.

At this point it is pointed out that the terms “a” and “one” do not necessarily refer to exactly one of the elements, although this is a possible embodiment, but can also denote a plurality of the elements. Similarly, the use of the plural also includes the presence of the element in question in the singular and, conversely, the singular also includes several of the elements in question. Furthermore, all of the features of the invention described herein may be claimed in any combination or in isolation from each other.

### BRIEF DESCRIPTION OF THE FIGURES

Further advantages, features and effects of the present invention are shown in the following description of preferred exemplary embodiments with reference to the figures, in which the same or similar components are designated by the same reference numerals. In the figures:

FIG. 1: shows a perspective view of an embodiment of a functional structure according to the invention.

FIG. 2: shows a perspective view of a surface of an embodiment of a functional structure according to the invention.

FIG. 3: shows a perspective view of a surface of an embodiment of a functional structure according to the invention.

FIG. 4: shows a perspective view of a surface of an embodiment of a functional structure according to the invention.

FIG. 5: shows a sectional view of an embodiment of a functional structure according to the invention.

FIG. 6: shows a perspective view of another embodiment of a functional structure according to the invention.

FIG. 7: shows a perspective view of another embodiment of a functional structure according to the invention.

FIG. 8: shows a perspective view of another embodiment of a functional structure according to the invention.

FIG. 9: shows a sectional view of another embodiment of a functional structure according to the invention.

FIG. 10: shows a diagram for the transmission behaviour of a functional structure according to the invention.

### DETAILED DESCRIPTION

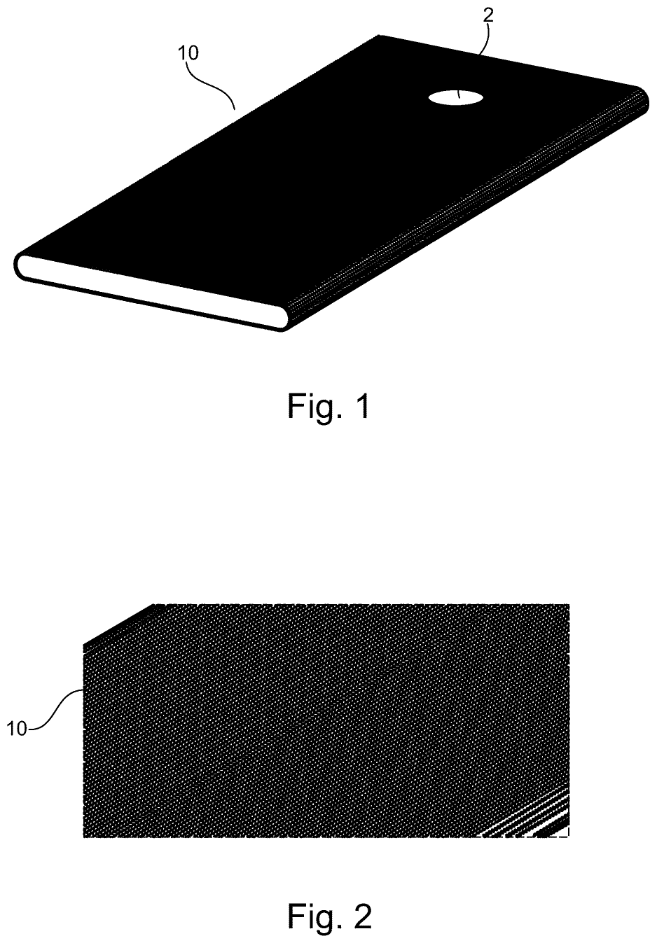

FIG. 1 shows an exemplary base body 10 of a high-frequency functional structure according to the invention.

The base body 10 shown in FIG. 1 is a test body for measuring the adhesion of an electrically conductive layer on the base body 10 and is therefore provided with a hole 2. Of course, the invention is not limited to such base bodies 10 in the form of test bodies.

The base body 10, which is provided with a metallic coating, can be fixed to a base through the hole 2 and various test procedures can then be carried out on it to test or estimate the adhesion, in particular the adhesive strength of the coating on the base body 10.

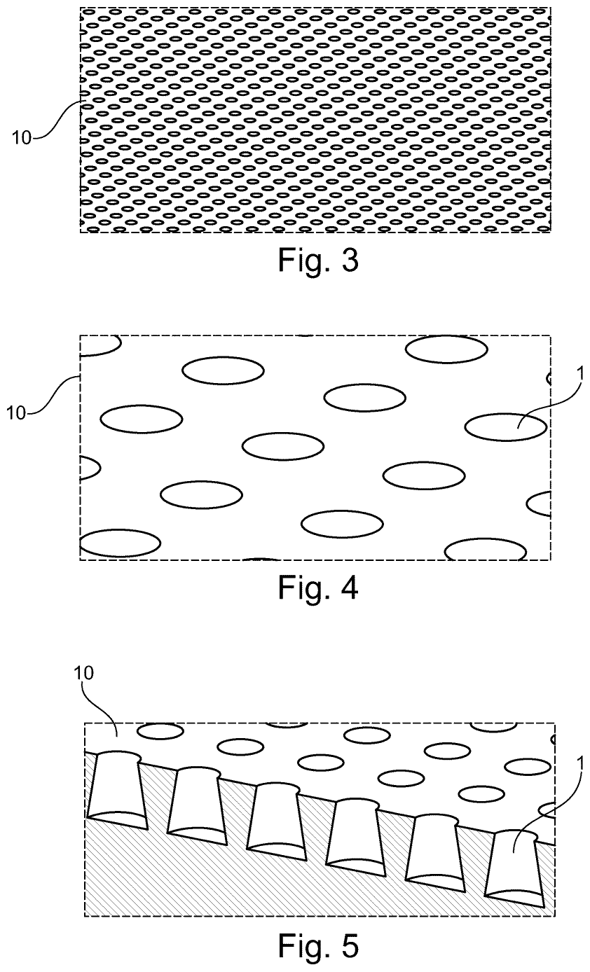

FIGS. 2 to 4 show increasingly enlarged sections of the surface of the base body 10. The largest enlargement of the surface of the base body 10 is shown in FIG. 4.

FIG. 4, for example, shows that the surface of the base body 10 is provided with recesses. The recesses 1 are arranged in a regular pattern on the surface of the base body 10, but can also be arranged irregularly. The recesses 1 can also have the same or different shapes. Several recesses 1 with one shape and further recesses 1 with another shape can also be arranged. The recesses 1 can therefore have any shape.

FIG. 5 shows the cross-section of the recesses 1. The recesses 1 are circular on the surface and widen conically in the depth direction. This means that the recesses 1 have an undercut in relation to the surface. The recesses 1 are therefore shaped like caverns.

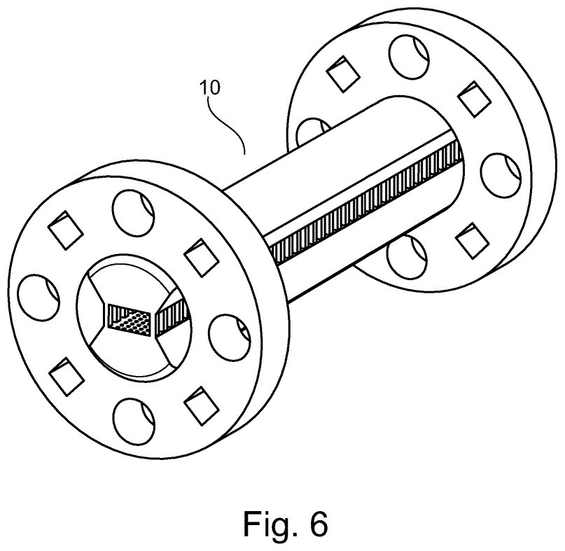

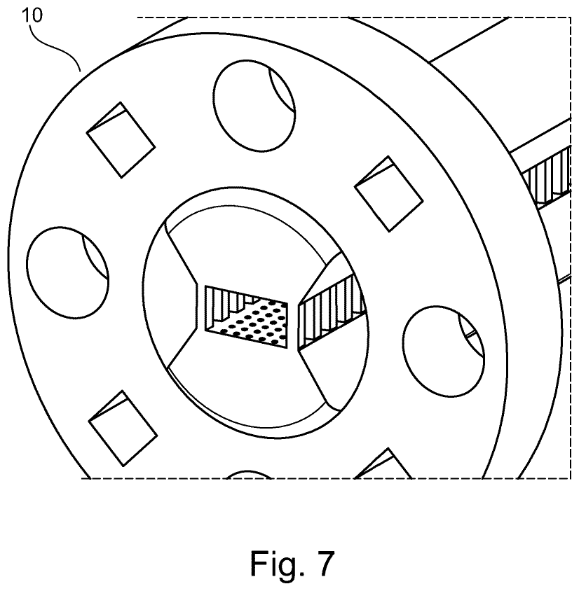

FIG. 6 shows a base body 10 for a slotted waveguide or hollow waveguide for conducting electromagnetic waves. The base body has two flanges and a channel for the waveguiding.

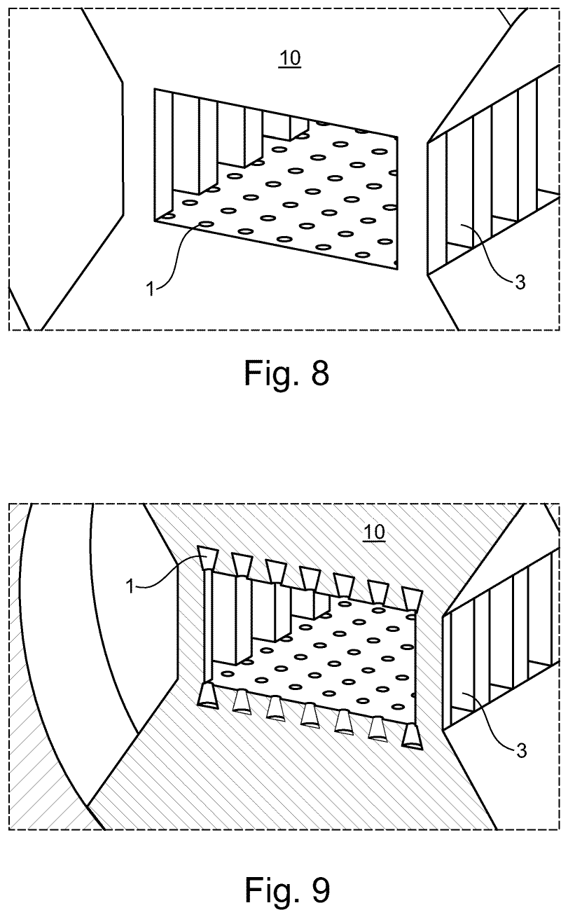

FIGS. 7 and 8 now show increasingly enlarged sections of the base body 10. The largest enlargement of the surface of the base body 10 is shown in FIG. 8.

Recesses 1 are arranged on one surface of the base body 10, as can be seen particularly clearly in FIG. 8.

Similarly, recesses 1 are arranged on a surface parallel to this surface, as shown in FIG. 9. The recesses 1 are circular on the surface and widen conically in the depth direction. This means that the recesses 1 have an undercut in relation to the surface. The recesses 1 are therefore shaped like caverns.

The two surfaces with the recesses are connected to each other by two slotted walls 3, creating a channel for waveguiding. The walls have slots, from which the name slotted waveguide is derived.

The printed surface does not represent a sharp boundary between the dielectric, e.g. air and metal, but can be described as a gradual transition for the penetrating electromagnetic field.

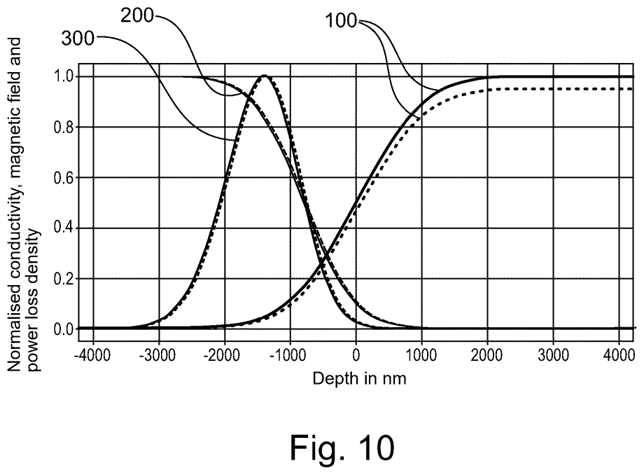

This material transition corresponds to the sum frequency function of the surface profile, as shown in FIG. 10.

The diagram in FIG. 10 shows the depth of recesses in nm on the x-axis and the normalised conductivity, the magnetic field and the power loss density on the y-axis. The solid curves are the respective measurement curves without recesses and the dashed lines are the respective measurement curves with recesses. The curves 100 represent the conductivity, the curves 200 represent the magnetic field and the curves 300 represent the power loss density.

The generation of mechanical roughness by introducing caverns of any shape mainly leads to a change in this function in the region after the centre surface (depth>0). Due to the low penetration depth of the electromagnetic field, the region in front of the centre surface is essentially relevant for the transmission behaviour. In this case, the mechanical roughness generated in this way results in only a minimal influence on the electromagnetic field and almost unchanged power loss density, which consequently leads to no deterioration of the transmission properties in the application.

The anchoring elements can have expansions of less than 10 nm or less than 1 μm to about 2-3 μm, in particular less than 10 μm.

1. A method for manufacturing a functional structure having the steps of:
providing a base body of the functional structure;
applying at least one metallic layer to a surface of the base body,
wherein the surface of the base body has one or more anchoring elements at least in certain areas, which are designed and arranged to improve an adhesion of the at least one metallic layer to the surface compared to an adhesion of the at least one metallic layer to a surface without anchoring elements.

2. The method according to claim 1, wherein the one or more anchoring elements comprise recesses penetrating into the surface and/or projections protruding from the surface and/or have undercuts and/or are produced by the roughness of the surface.

3. The method according to claim 1, wherein a plurality of anchoring elements are evenly or unevenly distributed on the surface, wherein the plurality of anchoring elements have the same shape or at least one anchoring element of the plurality of anchoring elements has a different shape.

4. The method according to claim 1 wherein the one or more anchoring elements are produced by a 3D printer.

5. The method according to claim 1, wherein a surface density of the one or more anchoring elements on at least one region of the surface is greater than one anchoring element per square centimetre, and wherein the surface density is a maximum of 100,000 anchoring elements per square millimetre.

6. The method according to claim 1, wherein the anchoring elements are produced during the manufacture of the base body or are attached to or inserted into the base body after manufacture.

7. The method according to claim 1, wherein the at least one metallic layer is applied by means of a wet-chemical process, wherein the microparticles and/or nanoparticles have nickel, copper, silver, gold, zinc, tin, chromium, palladium and/or platinum.

8. The method according to claim 1, wherein the at least one metallic layer is deposited by means of one of the following methods: PVD, CVD, sputtering, inkjet, aerosol jet, nanojet, roll-to-roll printing, screen printing, physical application using inks or pastes or lacquers, chemical methods using wet-chemical deposition or galvanic deposition.

9. The method according to claim 1, wherein the method comprises the further step of:
applying at least one further metallic layer to the base body by means of a galvanic or wet-chemical process.

10. The method according to claim 1, wherein the at least one metallic layer covers the anchoring elements after application of the at least one metallic layer in such a way that the at least one metallic layer has a functional, smooth, flat and/or continuous surface, wherein the anchoring elements are visible, partially visible or invisible.

11. The method according to claim 1, wherein the one or more anchoring elements are arranged only on surfaces of the base body that have no function or only or also on inner sides of a slotted, hollow waveguide or on radiating surfaces of an antenna.

12. The method according to claim 1, wherein the functional structure is designed to conduct an electromagnetic wave, wherein the anchoring elements each have an extension in the direction of propagation of the electromagnetic wave, which is less than the whole of the wavelength of the electromagnetic wave.

13. The method according to claim 1, wherein regions of an outermost layer of the at least one metallic layer are smoothed by means of galvanic smoothing or smoothing of the base body before the outermost layer is applied.

14. The method according to claim 1, wherein the base body is manufactured by an additive method, wherein the additive method comprises SLS, SLA, DLP, multijet, 2-photon printing, aerosol jet, inkjet, nanojet, FDM, SLM and/or EBM.

15. The method according to claim 1 wherein the base body consists partially or completely of ceramic, plastic, or metal, and/or wherein the base body is a hollow body, an inside of the hollow body coated with the at least one metallic layer, and/or wherein the base body is formed or produced in one piece or in several parts.

16. The method according to claim 1, wherein the functional structure is or comprises an electrical or high-frequency functional structure, a high-frequency line, or a filter or a resonator or a coupler or another passive HF part or component of a solar system, a solar cell, a touch screen, a smart glass, a wearable or an LED or a moulded interconnect device (MID) or mechatronic integrated device (MID) or a decorative structure.

17. A functional structure that has been partially or completed manufactured by means of the method according to claim 1, the functional structure having the at least one metallic layer on the surface of the base body provided with the anchoring elements.

18. The functional structure according to claim 17, wherein the one or more anchoring elements comprise recesses penetrating into the surface and/or projections protruding from the surface and/or have undercuts and/or are produced by the roughness of the surface.

19. The functional structure according claim 17, wherein the at least one metallic layer covers the anchoring elements in such a way that the at least one metallic layer has a functional, smooth, flat and/or continuous surface, and wherein the one or more anchoring elements are visible, partially visible or invisible.

20. The functional structure according to claim 17, wherein the one or more anchoring elements are arranged only on surfaces of the base body that have no function or only or also on inner sides of a slotted, hollow waveguide or on radiating surfaces of an antenna.
